(19) United States
(12) Patent Application Publication
(10) Pub. No.: US 2021/0246609 A1
(43) Pub. Date: Aug. 12, 2021

(54) MATERIALS CONTAINING CELLULOSE NANOFIBERS

(71) Applicants: THE UNIVERSITY OF QUEENSLAND, St Lucia, Queensland (AU); DUGALUNJI ABORIGINAL CORPORATION, Camooweal, Queensland (AU)

(72) Inventors: Darren James MARTIN, St Lucia, Queensland (AU); Katarzyna KEPA, Taringa, Queensland (AU)

(21) Appl. No.: 17/251,517

(22) PCT Filed: Jun. 11, 2019
(86) PCT No.: PCT/AU2019/050599

§ 371 Date: Dec. 11, 2020

(30) Foreign Application Priority Data
Jun. 11, 2018 (AU) 2018902088

(51) Int. Cl. D21C 9/00; D21H 11/12; D21H 11/18; B32B 27/08; B32B 27/10; B32B 27/12; B32B 29/02; B32B 29/00; B32B 37/12

(52) U.S. Cl. CPC D21C 9/007; D21H 11/12; D21H 11/18; B32B 27/08; B82Y 30/00; B32B 27/12; B32B 29/02; B32B 29/005; B32B 37/12; B32B 27/10

(57) ABSTRACT

A material containing cellulose nanofibres, the material comprising a gel material comprising cellulose nanofibres in an aqueous medium, the cellulose nanofibres having 10% or more by weight hemicellulose. The cellulose nanofibres have a diameter of less than 100 nm, or less than 50 nm, or less than 20 nm. The gel material can be used as an adhesive to make laminates or to make paper by dewatering the gel material.

### TECHNICAL FIELD

The present invention relates to materials containing cellulose nanofibers.

### BACKGROUND ART

In recent years, the demand on sustainable materials has been increasing worldwide in order to reduce dependence on petrochemicals due to their negative environmental footprint. However, the development of such materials is a challenging task as they should demonstrate good mechanical performance, be economically attractive and feasible to implement at the industrial scale.1 Moreover, green materials manufacture should be designed with low energy demand processes. Cellulose fibers derived from plants possess one of the highest specific strengths and moduli amongst natural materials, and higher than many other engineering materials such as plastics, metals, and ceramics. The Young's modulus of a single cellulose I nanofiber in the axial direction is between 110-220 GPa. The additional advantages of utilizing biomass are its abundance, availability in considerable quantities, the ability of being replaced by new growth, and low cost.6 Therefore, plant fibers have the potential of replacing synthetic materials and improving the recyclability and biodegradability of products.

Unfortunately, to date, the extraction of nanofibrillated material from biomass involves complicated and energy intensive processes. Usually this entails a mechanical, chemical or enzymatic pretreatment followed by mechanical disintegration into microfibrillated cellulose (MFC) or cellulose nanofibers (CNF). The choice of applied mechanical refining technique can influence the characteristics of the cellulose such as, morphology, crystallinity, and aspect ratio. Importantly, the process or processes selected can have an enormous bearing on the cost of the product. Early work in the 1980s disintegrated pulp by means of high-pressure homogenization (HPH) to produce MFC. Currently, several mechanical techniques can yield even smaller, cellulose nanofibers from various sources. Numerous review papers have listed the most widely used mechanical processes for the fibrillation of biomass into MFC and CNF. Some of the common approaches include use of HPH, ultra-fine grinding, microfluidization and high-energy ultrasonication treatment. However, these processes are associated with very high energy consumption, which adds cost and therefore limits the application and number of addressable markets for this high-performance material. Recently, twin-screw extrusion (TSE) and high-energy ball milling (HEBM) were utilized as an alternative, novel defibrillation techniques of bleached wood pulps. Ball milling is a grinding method used primarily in the preparation of minerals and metal alloys. However, it has also been successfully employed to convert cellulose-containing materials such as, oil palm empty fruit bunch, microcrystalline cellulose, or bleached jute and spinifex fibers into nano-sized particles. The process can be conducted dry or wet, therefore it can be practicable for the fibrillation of pulp. TSE is used primarily in the processing of synthetic thermoplastic polymers, but recently has also been used effectively to process bio-plastics and for the reactive pretreatment of lignocellulosic pulps. Researchers have successfully used this method to obtain CNF and MFC at very high solid content between 17-28% from bleached and/or TEMPO-oxidized wood pulps. Nevertheless, bleaching and TEMPO-oxidation steps are associated with additional energy requirements and more importantly the use of toxic chemicals, which have negative impacts on the environment. It has been reported that bleaching and oxidation were inevitable to process the material with the means of TSE and suggested, that additional mechanical pretreatments should be investigated to make TSE possible for non-bleached pulps. Generally, the biomass acquired from non-wood resources, such as grasses, is easier to defibrillate as it comprises less lignified tissue than wood. Therefore, in the case of non-wood material, alkali hydrolysis is typically more effective in loosening the structure of fiber bundles.

In the last few decades, the use of natural fibres to reinforce polymer composites has been increasing because of their sustainability, renewability, biodegradability, low thermal expansion, manufacturer-friendly attributes such as low density and abrasiveness, excellent mechanical properties such as very high specific stiffness and strength and consumer-friendly attributes such as lower price and higher performance. A typical natural microfibre consists of bundles of nanofibres which in turn consist of several or more elementary (primary) nanofibrils formed by cellulose chains (a homopolymer of glucose), concreted by/in a matrix containing lignin, hemicellulose, pectin and other components. The diameter of primary cellulose nanofibrils is typically in the range 3-4 nm. The nanofibrils consist of monocrystalline cellulose domains linked by amorphous domains. Amorphous regions act as structural defects and can be removed under acid hydrolysis, leaving cellulose rod-like nanocrystals, which are also called whiskers, and have a morphology and crystallinity similar to the original cellulose fibres. Depending on the source of cellulose, the cellulose content varies from 35 to 100%. These fibres, isolated in their primary nanofibrillar form exhibit extraordinarily higher mechanical properties (stiffness/strength) than at the microscale (as bundles of nanofibres) or in their natural state. In recent years, these nanocrystalline cellulose fibres have been explored as biologically renewable nanomaterials that can be applied in several engineering applications. While numerous methods have been explored for the production of microfibrillated cellulose (MFC), which by definition (Reference: Robert J. Moon, Ashlie Martini, John Nairn, John Simonsen and Jeff Youngblood, ‘Cellulose nanomaterials review: structure, properties and nanocomposites’ Chem. Soc. Rev., 2011, 40, 3941-3994), consists of cellulose fibres with diameters in the range of 20-100 nm and a length in the range between 0.5 μm and tens of microns, the production of nanofibrillated cellulose (NFC), and cellulose nanocrystals (CNCs) is more challenging due to the requirement to separate or deconstruct the cellulose fibres and/or crystals to a much greater degree. Attempts to date to produce these two types of nanocellulose (CNCs and NFCs) have focused on the use of chemical, physical, mechanical and enzymatic steps as pre-treatments between conventional pulping processes and final mechanical defibrillation processing alone or in combinations thereof. For NFC, the prior art refers to a fibre diameter in the range of 3-20 nm and a length in the range between 0.5 and 2 μm. These nanofibrils can be further made up of primary cellulose nanofibrils typically having a diameter of 3-4 nm. For example, a cellulose nanofibril with a diameter of 10 nm may consist of a bundle of a few primary cellulose nanofibrils with 3-4 nm diameter. For CNC, the prior art refers to fibre/crystal diameters/widths in the range of 3-20 nm and lengths of up to 500 nm (except the special example of tunicate CNCs or t-CNCs, which have a higher aspect ratio).

For isolation of microfibres, which are called microfibrillated cellulose (MFC) with diameters range of 20-100 nm and length in the range of 0.5-10's μm, mechanical methods such as ultrasonication, homogenisation, milling, grinding, cryocrushing, or combinations of these are widely used to defibrillate the macroscale bleached pulp fibres into MFC fibrils which essentially consist of bundles of nanofibrils. In order to further refine and separate the MFC into its constituent nanofibrils and to isolate these further thinner particles called nanofibrillated cellulose (NFC) or cellulose nanofibrils (CNF), with diameters in the range of 3-20 nm and lengths in the range of 500-2000 nm, a significantly larger amount of mechanical energy typically needs to be applied than that required to refine material to the microfibrillar level. In reported methods, additional chemical or enzymatic pre-treatments applied after pulping and bleaching but prior to mechanical processing are usually claimed to be beneficial for reducing both mechanical energy consumption and resultant nanofibre diameter, as the chemical agents can aid in the removal of matrix materials such as lignin and hemicellulose that bind the fibres together.

Delignification and bleaching are chemical processes widely used in the paper manufacturing industry and are key steps in the pulping process.

When a large amount of mechanical energy is applied to a cellulosic feedstock or the cellulose is exposed to harsh chemical pre-treatments, the cellulose fibres can be prone to breakage and/or degradation, thereby reducing their length and aspect ratio. Therefore, the production of nanocellulose is typically governed by a delicate balance between the requirement to input sufficiently large amounts of energy in order to isolate the nanofibres and the propensity of this large amount of energy to break fibres, thereby reducing their length and aspect ratios. Consequently, efforts to manufacture nanocellulose at commercial scale have been hindered by the high cost introduced by these additional processing steps and the challenge of avoiding fibre breakdown and/or degradation during processing. In manufacturing nanocellulose, mechanical processing is typically performed by passing a cellulosic feedstock through a mechanical processing step a number of times to facilitate the gradual breakdown of the cellulose to its nanoscale fibrils. For example, cellulosic feedstock material may be passed through equipment such as a homogeniser or disc refiner several times or more before the cellulose is sufficiently separated that predominantly nanofibres are yielded. In a commercial process, this requirement to pass the material through the same step multiple times can result in high energy costs and long processing times, reducing the commercial attractiveness of the process.

Literature published before 2011 tends to use the terms MFC and NFC interchangeably, with these terms being used for both nanofibrils and microfibrils. In this specification, we distinguish between MFCs and NFCs, using the definitions given by Moon et. al. Chem Soc. Review' 2011. Throughout this specification, the terms “MFC” (microfibrillated cellulose) and “CMF” (cellulose microfibre) are used to describe fibrils, including bundles of nanofibrils, with a diameter above 20 nm and length in 10s of microns. The terms “NFC” (nanofibrillated cellulose) and “CNF” (cellulose nanofibre) are used to describe nanofibrils having a diameter between 3 to 20 nm. The term “CNC” is used to describe cellulose nanocrystals, which are rod-like or whisker shaped particles that are typically produced after acid hydrolysis of bleached pulp, MFC or NFC. CNCs with a high aspect ratio (3-5 nm diameter, 50-500 nm in length), are essentially 100% cellulose and are highly crystalline (54-88%). The CNCs obtained via acid hydrolysis in the present invention are longer (up to 1.5-2 microns or longer) than CNCs obtained in the prior art.

In our international patent application number PCT/AU2014/050368 (WO 2015/074120), the entire contents of which are herein incorporated by cross-reference, we disclose a unique nanocellulose material of plant origin that has a high hemicellulose content. In particular, the nanocellulose material is extracted from plants having C4 leaf anatomy. Specific examples disclosed in this patent application produce nanocellulose having a hemicellulose content of greater than 30% by weight in the nanocellulose product. This is in stark contrast to nanocellulose disclosed in the prior art that ultimately has very low to effectively zero levels of hemicellulose due to the harsh processing conditions that are used to form the nanocellulose product. The nanocellulose product of this patent application may be derived from Australian spinifex (Triodia pungens).

Our international patent application number PCT/AU2015/050773, the entire contents of which are here incorporated by cross-reference, describes use of the nanocellulose derived from plants having C4 leaf anatomy to make composite elastomeric materials. The nanocellulose is effectively acting as a reinforcing agent in the composite elastomeric materials.

It will be clearly understood that, if a prior art publication is referred to herein, this reference does not constitute an admission that the publication forms part of the common general knowledge in the art in Australia or in any other country.

### SUMMARY OF INVENTION

In a first aspect, the present invention provides a material containing cellulose nanofibres, the material comprising a gel material comprising cellulose nanofibres in an aqueous medium, the cellulose nanofibres having 10% or more by weight hemicellulose.

The cellulose nanofibres may have a diameter of less than 100 nm, or less than 50 nm, or less than 20 nm. The cellulose nanofibres may have a diameter of from 3 nm to 100 nm, or from 3 nm to 50 nm, or from 3 nm to 20 nm.

In one embodiment, the cellulose nanofibres have 15% or more by weight hemicellulose. In one embodiment, the cellulose nanofibres have 20% or more by weight hemicellulose. In one embodiment, the cellulose nanofibres have 25% or more by weight hemicellulose. In one embodiment, the cellulose nanofibres have 30% or more by weight hemicellulose.

In some embodiments of the present invention, the cellulose nanofibres are quite different to conventional cellulose nanofibres, which consists almost entirely of cellulose. The cellulose nanofibres suitable for use in embodiments of the present invention include cellulose, hemicellulose, lignin and some extractives. The extractives could include some resins.

In some embodiments, the cellulose nanofibres comprise from 10 to 25%, by weight, lignin, 35 to 70% by weight cellulose and 2 to 10%, or 2 to 8% extractives. The amount of hemicellulose present in the cellulose nanofibres is as described above

In one embodiment, the gel contains from 2 mg/ml (w/V) cellulose nanofibres to 20% w/V cellulose nanofibres, or from 2 mg/ml (w/V) to 15% w/V cellulose nanofibers. The content of the cellulose nanofibres in the gel may vary in accordance with the required use of the gel material. At the upper levels of cellulose nanofibres content specified above, the gel becomes very thick, almost a paste.

In some embodiments, rheology additives may be added to the gel in order to effect or controlled the rheology of the gel. For example, rheology modifiers may be added to increase the viscosity of the gel or to result in the gel having thixotropic properties. A person skilled in the art will understand that there are many commercially available rheology modifiers that could be used in this regard. One example is a modified new rear rheology additive sold by BYK-Chemie GmbH under the trade name BYK-D 240. Other rheology modifiers may also be used.

In some embodiments, the mixture of aqueous medium and cellulose nanofibres may be subjected to ultrasonic energy in order to assist in forming the gel.

In one embodiment, the aqueous medium comprises water.

In one embodiment, the aqueous medium comprises water and an alkali. In one embodiment, the aqueous medium has a pH of greater than 7. In one embodiment, the aqueous medium comprises water and sodium hydroxide.

In one embodiment, the aqueous medium comprises an aqueous medium remaining with the cellulose nanofibres following treatment of a plant material to form the cellulose nanofibres. In one embodiment, the treatment of the plant material to form the cellulose nanofibres includes a mild alkali treatment. The mild alkali treatment may include treating the plant material with an alkali solution having an alkalinity equivalent to 2% to 15% NaOH, or 2% to 14%, or 2% to 10%, or 2% to 7%, or 2% to 5% NaOH As the alkalinity of the treatment solution increases, the hemicellulose content of the cellulose nanofibres decreases. Accordingly, in embodiments where a high hemicellulose content is desired, lower levels of alkaline in the treatment to form the cellulose nanofibres should be used.

In one embodiment, the material of the present invention is formed by treating plant material with the mild alkali treatment, followed by mechanical processing to form the cellulose nanofibres. The plant material may be washed with water following the mild alkali treatment. The washing may involve washing the plant material with hot water. The temperature of the hot water may range from 40° C. to 100° C., or from 40° C. to 80° C., or be about 60° C., or be about 100° C. This washing step removes dissolved material from the plant material. Washing may continue until the effluent is at neutral pH. A pulp containing the alkali treated plant material and water may then be sent to mechanical processing. The pulp may be diluted prior to mechanical processing.

The mechanical processing may include a number of different processes, including shear mixing, high-energy ball milling, passing the pulp through an extruder, such as a twin screw extruder, high-pressure homogenisation, or the like. The mechanical processing causes mechanical disintegration of the plant material into microfibrillated cellulose or cellulose nanofibres. For convenience, the term “cellulose nanofibres” will be used throughout this specification to refer to both microfibrillated cellulose and cellulose nanofibres. The term “nanocellulose” will be used interchangeably with “cellulose nanofibres”.

The product recovered from the mechanical processing step comprises a containing water and cellulose nanofibres. This pulp may have part of the water removed therefrom to form the gel material of the first aspect of the present invention. Removal of the water may take place by any known processing, including evaporation, centrifugation, filtration, or the like.

In other embodiments, the cellulose nanofibres are recovered from the pulp by drying and the gel material of the first aspect of the present invention is formed by subsequently adding an aqueous medium, such as water, to the dried fibres.

The present inventors believe that the rheological properties of the gel material may be as described in the following paper which describes some aspects of the rheological properties of cellulose nanofibres suspensions: Rheology of cellulose nanofibers suspensions: Boundary driven flow, Journal of Rheology 60, 1151 (2016); https://doi.org/10.1122/10.4960336)

The material of the first aspect of the present invention exhibits high self adhesion. This enables the material to be used as an adhesive in the manufacture of other products, such as laminates. When the gel material of the first aspect of the present invention has been dried, it exhibits higher relative hydrophobicity and high material toughness. Without wishing to be bound by theory, the present inventors believe that a combination of the mild processing conditions used to form the cellulose nanofibres and the high hemicellulose content of the cellulose nanofibres results in enhanced adhesion properties of the material. The present inventors also postulate that the hemicellulose content is present as a thin coating around the cellulose component of fibres, leading to enhanced the ability of the cellulose fibres. The hemicellulose interphase appears to maintain intimate bonding to the cellulose nanofibres and acts like an inbuilt, tough thermoplastic matrix or adhesive.

The above properties also mean that cellulose nanopaper having desirable properties may also be made. Accordingly, in a second aspect, the present invention provides paper made from cellulose nanofibres, characterised in that the cellulose nanofibres have a hemicellulose content of at least 10% by weight. This paper may be described as cellulose nanopaper.

In one embodiment, the cellulose nanopaper is made by dewatering a pulp or gel containing the cellulose nanofibres. The cellulose nanopaper may be heated during formation in order to increase adhesion between the cellulose nanofibres. The cellulose nanopaper may be pressed during formation in order to increase adhesion between the cellulose nanofibres. The cellulose nanopaper may be hot pressed during formation in order to increase adhesion between the cellulose nanofibres.

Cellulose nanopaper in accordance with the second embodiment of present invention is tough, dense and ductile, exhibits higher relative hydrophobic behaviour and has excellent formability. It presents as an excellent candidate for use in packaging solutions.

The present inventors have discovered that the gel material of the first aspect of the present invention also has properties that make it suitable for use as an adhesive or an adhesive layer in the manufacture of other products. Accordingly, in a further aspect, the present invention provides a product having a first component adhered to a second component, characterised in that gel material comprising cellulose nanofibres having 10% or more, by weight, hemicellulose in an aqueous medium is used as an adhesive to adhere the first component to the second component.

In one embodiment, a gel layer of the gel material is placed between the first component and the second component. In one embodiment, the gel layer is dewatered during manufacture of the product. In one embodiment, the first component, the second component and the gel layer are pressed to adhere the first component to the second component. In one embodiment, the first component, the second component and the gel layer are heated to adhere the first component to the second component. In one embodiment, the first component, the second component and the gel layer are hot pressed to adhere the first component to the second component.

In one embodiment, the product comprises a laminate having a first sheet and a second sheet adhered to the first sheet, with the gel layer adhering the first sheet to the second sheet. The laminate may comprise a plurality of sheets, with a gel layer being located between each sheet in order to adhere the gel layer to each sheet.

In one embodiment, the laminate is formed by placing a gel layer on the first sheet, placing the second sheet on the gel layer (and optionally placing further alternating layers of gel layer and a further sheet) and pressing the sheets to remove water from the gel layer and to adhere the sheets to each other. Pressing of the sheets may also involve hot pressing of the sheets. The laminate may then be dried. For example, the laminate may be dried by heating to an elevated temperature, such as to a temperature of from 100° C. to 150° C.

The sheets may comprise paper sheets, sheets of hemp, sheets of flax, fibreglass sheets, cardboard sheets, cloth sheets, fabrics sheets, woven sheets, nonwoven sheets or the like. The laminate may be used as a packaging material. The laminate may be formed into quite complex shapes by pressing the sheets and gel layers into a mould and dewatering the sheets and gel layers in the mould. The mould may be provided with perforations to allow excess liquid to be squeezed out during the pressing process.

In other embodiments, the sheets may comprise polymeric materials. The sheets may comprise biodegradable polymeric materials.

Other materials may be added to the laminate including biodegradable thermoplastics and fire retardants. The biodegradable thermoplastics may include PHA (polyhydroxyalkanoates). The biodegradable thermoplastics and/or fire retardants may be added to the gel layer. The fire retardants may be present in the sheet material.

In a further aspect, the present invention provides a process for producing an article in which a first component is adhered to a second component, the process comprising applying a layer of the gel material as described herein to the first component, placing at least part of the second component in contact with the gel material and dewatering the gel material such that the first component adheres to the second component.

In one embodiment, the first component, gel material and second component are pressed together. In one embodiment, the first component, gel material and second component are hot pressed together. The article may be heated in order to remove water from the gel layer.

In one embodiment, the first component and the second component comprise a first sheet and a second sheet and the article comprises a laminate. In one embodiment, the laminate is formed into a shaped product by placing the first sheet, the gel layer and the second sheet into a mould and pressing the further sheet, gel layer and second sheet into the mould. The mould may be provided with one or more holes in order to enable water to be removed from the mould.

The process for producing the article may also include the step of heating the article to an elevated temperature. The article may be heated to a temperature in the range of from 100° C. to 150° C.

The gel layer may be applied by dipping, rolling or spraying onto the sheets. The gel layer and the sheet may comprise a prepreg component.

Using a thick/viscous gel layer of cellulose nanofibres in accordance with this aspect of the present invention allows the layup of complex shapes and a totally water-based approach, particularly when combined with paper sheets or sheets of other biodegradable material, gives a very green and totally compostable or recyclable solution. The high hemicellulose content and lignin content gives high relative hydrophobicity to the article, which provides for water repellence and humidity resistance, as well as thermoplasticity and formability, which are attractive for a number of packaging solutions.

The toughness and impact properties of the article should be very impressive and should be able to compete with glass-filled polypropylene currently used in automotive panels. The density of this composite should be quite lightweight. Ultimate tensile strength could approach 150 MPa, with extension to break of about 30%, which is comparable to a number of thermoplastics currently being used.

The present inventors have also postulated that the cellulose nanofibres having a hemicellulose content of at least 10% by weight, in exhibiting good adhesion and toughness, make an excellent candidate as a matrix material in its own right, where it might form a host matrix to properly modifying agents, such as reinforcing agents.

Accordingly, in another aspect, the present invention comprises a composite material comprising a matrix made from cellulose nanofibres having a hemicellulose content of at least 10% by weight, the composite material including one or more property modifying agents. In one embodiment, the one or properly modifying agents comprise a reinforcing agent. Reinforcing agent may comprise glass fibre, carbon fibre, graphene, metal fibres, flake material, platelet-shaped material or the like.

The one or more property modifying agents may be dispersed throughout the matrix made from the cellulose nanofibres.

This aspect of the present invention represents a fundamental shift in thinking from previous attempts to use the cellulose nanofibres as reinforcing agents in other matrices. In this embodiment of the present invention, the cellulose nanofibres themselves form the basic matrix of the composite material, with the property modifying agents forming additives to that matrix.

In one embodiment, the composite material of this aspect of the present invention comprises the matrix formed from the cellulose nanofibres, the matrix comprising at least 60% by weight, or at least 70% by weight, or at least 80% by weight, or at least 85% by weight, or at least 90% by weight, or at least 95% by weight, or at least 97% by weight, or at least 98% by weight, or at least 99% by weight, of the composite material. The one or more property modifying agents may comprise less than 40% by weight, or less than 30% by weight, or less than 20% by weight, or less than 50% by weight, or less than 10% by weight, with 5% by weight, or less than 3% by weight, or less than 2% by weight, or less than 1% by weight, of the composite material.

The cellulose nano fibres (or nano cellulose) using the present invention is suitably derived from a grass species having C4-leaf anatomy. In one embodiment, the plant material is derived from a drought-tolerant grass species. In one embodiment, the plant material is derived from arid grass species. In one embodiment of the present invention, the plant material is derived from Australian native arid grass known as “spinifex”. Spinifex (also known as ‘porcupine’ and ‘hummock’ grass) is the long-established common name for three genera which include Triodia, Monodia, and Symplectrodia (not to be confused with the grass genus Spinifex that is restricted to coastal dune systems in Australia). Hummock grassland communities in arid Australia are dominated by spinifex species of the genus ‘Triodia’. There are 69 described species of Triodia, which are long-lived and deep rooted allowing root growth to penetrate through tens of metres under the ground. Of the 69 species, abundant species are two soft species called T. pungens, T. shinzii and two hard species T. basedowii, T. longiceps. T. pungens has a typical composition of: cellulose (37%), hemicellulose (36%), lignin (25%) and ash (4%) in the un-washed form, such that hemicellulose content makes up 37% of the lignocellulosic content.

Example plants with C4 leaf anatomy that may be used in the present invention include Digitaria sanguinalis (L.) Scopoli, Panicum coloratum L. var. makarikariense Goossens, Brachiaria brizantha (Hochst. Ex A. Rich) Stapf, D. violascens Link, P. dichotomiflorum Michaux, B. decumbens Stapf, Echinochloa crus-galli P. Beauv., P. miliaceum L., B. humidicola (Rendle) Schweick., Paspalum distichum L., B. mutica (Forsk.) Stapf Setaria glauca (L.) P. Beauv, Cynodon dactylon (L.) Persoon, Panicum maximum Jacq., S. viridis (L.) P. Beauv, Eleusine coracana (L.) Gaertner, Urochloa texana (Buckley) Webster, Sorghum sudanense Stapf, E. indica (L.) Gaertner, Spodiopogon cotulifer (Thunb.) Hackel, Eragrostis cilianensis(Allioni) Vignolo-Lutati, Chloris gayana Kunth, Eragrostis curvula, Leptochloa dubia, Muhlenbergia wrightii, E. ferruginea (Thunb.) P. Beauv., Sporobolus indicus R. Br. var. purpureo-suffusus (Ohwi) T. Koyama, Andropogon gerardii, Leptochloa chinensis (L.) Nees, grasses of the Miscanthus genus (elephant grass), plants of the genus Salsola including Russian Thistle, ricestraw, wheat straw, and corn stover, and Zoysia tenuifolia Willd.

Other arid grasses that may be used to produce the nanocellulose suitable for use in the present invention may include Anigozanthos, Austrodanthonia, Austrostipa, Baloskion pallens, Baumea juncea, Bolboschoenus, Capillipedium, Carex bichenoviana, Carec gaudichaudiana, Carex appressa, C. tereticaulis, Caustis, Centrolepis, Chloris truncate, Chorizandra, Conostylis, Cymbopogon, Cyperus, Desmocladus flexuosa, Dichanthium sericeum, Dichelachne, Eragrostis, Eurychorda complanata, Evandra aristata, Ficinia nodosa, Gahnia, Gymnoschoenus sphaerocephalus, Hemarthria uncinata, Hypolaeana, Imperata cylindrical, Johnsonia, Joycea pallid, Juncus, Kingia australis, Lepidosperma, Lepironia articulate, Leptocarpus, Lomandra, Meeboldina, Mesomelaena, Neurachne alopecuroidea, Notodanthonia, Patersonia, Poa, Spinifex, Themedo triandra, Tremulina tremula, Triglochin, Triodia and Zanthorrhoea, Aristida pallens (Wire grass), Andropogon gerardii (Big bluestem), Bouteloua eriopoda (Black grama), Chloris roxburghiana (Horsetail grass), Themeda triandra (Red grass), Panicum virgatum (Switch grass), Pennisetum ciliaris (Buffel grass), Schizachyrium scoparium (Little bluestem), Sorghatrum nutans (Indian grass), Ammophila arenaria (European beach grass) and Stipa tenacissima (Needle grass).

In all aspects of the present invention, the cellulose nanofibres may be as described with reference to all embodiments of the first aspect of the present invention.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 shows a schematic side view of a moulded article in accordance with the present invention.

### DESCRIPTION OF EMBODIMENTS

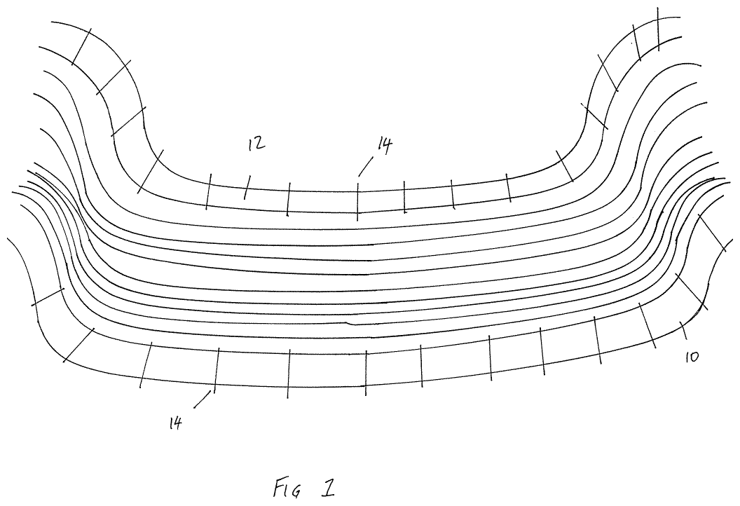

In FIG. 1, a mould has a female portion 10 and a male portion 12. The mould portions 10, 12 have holes or perforations 14 to allow excess water to be squeezed out as the male portion 12 mould is closed and pressed towards the female mould portion 10. A plurality of alternating layers of sheets of material, such as paper, hemp mat, flax mat, fibreglass sheets, etc and layers of a gel material comprising cellulose nanofibres having at least 10% hemicellulose content in an aqueous medium are placed in the female mould portion 10. In some of the experimental work conducted to date, the hemicellulose content was around 23%. The male mould portion 12 is then closed and pressed towards the female mould portion 10, which compresses the alternating layers of sheets and gel material. This results in water being squeezed out from the material and the alternating layers of sheets and gel material being compressed together. The mould may be heated to assist in the cellulose nanofibres adhering to the sheets. The mould may then be opened and the formed article removed.

In another embodiment, “laying up” of the composite material may occur by laying down a first sheet and spraying the CNF gel layer onto the first sheet, followed by applying a second sheet to the gel layer, and so forth. The spraying step could assist in removing some of the excess water, in which case these breaks that may comprise a pseudo-spray drying step.

In other embodiments, water may be removed from the gel by heating, such as by the use of microwaves, steam drying, superheated steam, infrared radiation or the like. Heating is anticipated to be especially useful where manufacturing processes require the rapid removal of water from the gel.

### Example—Preparation of Cellulose Nanofibers

Spinifex grass (Triodia pungens) was collected from Camooweal in Queensland, Australia. NaOH flake (98% purity) was purchased from Alfa Aesar. Calcofluor white was obtained from Sigma-Aldrich. Reverse osmosis (RO) purified water was used throughout.

Grass was pre-screened and the leaves were selected and cut-off from the woody stem. Thus pre-screened material is referred to as the “tips”. The tips were then cut to about 5 cm with a guillotine, washed three times with water at 85° C. at approximately 1:35 grass to water ratio in a 100 L tank and dried at room temperature over 3 days. The tips were then ground to <0.5 mm. The material was pre-soaked in water and treated with a 2% (w/v) aqueous NaOH solution using a grass-to-liquid ratio of 1:10 for 2 h at 80° C. in a 50 L jacketed stainless steel tank. The mixture was vigorously stirred to ensure uniform mixing. Subsequently, the NaOH-treated pulp was washed with hot water (approximately 60° C.) to remove dissolved material, until the effluent was neutral. The pulp was stored at 4° C.

The chemical composition analysis of the spinifex grass was performed to evaluate the effectiveness of the alkaline treatment process prior to mechanical processing. The treatment is aimed to reduce the issue of clogging and energy consumption of the machines by removal of lignin and extractives, and softening material. The results are presented in Table 1. The data revealed a significant (p=0.003) reduction of lignin from 18.4% (total amount of acid soluble and insoluble lignin) to 12.7% after alkaline pulping as compared to hot water-washed grass. The treatment resulted in a twofold increase in the ratio of cellulose to lignin in the pulp (Table 1). The reduction in the amount of lignin is attributed to the solubilization of lignin due to its depolymerization and formation of free phenolic groups. Use of aqueous alkali solutions at elevated temperatures is commonly applied for this purpose. Lignin provides stiffness, and rigidity of the plant as well as it repulses water from the cell wall volume. Therefore, chemical removal of this component can be related to reduction of stiffness of the fibers, which can improve efficiency of mechanical fibrillation by lower cohesion between the cell wall bundles. Non-wood lignocellulosic resources are generally easier to fibrillate than wood due to usually lower amount of lignin in their cell wall. Consequently, in the case of non-wood material, alkali hydrolysis can be typically milder and more effective. The alkaline pulping also removed a significant (p=0.006) amount of extractives (Table 1). Spinifex T. pungens is a resinous species therefore, the extractives could be attributed to this remnant resin trapped in the leaves, unable to be removed with only hot water washing. The resin makes the material sticky, which could cause adhesion to the machinery parts, hence its removal is important prior to processing. Since lignin and resin are relatively hydrophobic components of spinifex, their presence can hinder swelling of cellulose and impede the subsequent fractionation process. Use of alkali solution can also influence the susceptible carbohydrates. As can be seen in Table 1 the ratio of cellulose to hemicellulose increased after NaOH treatment. It is possible that at high temperature and pH the structure of cellulose was affected. However, it is more likely that the more readily accessible hemicelluloses undergo degradation and/or dissolution in the alkaline medium. A similar reduction in hemicellulose content attributed to its degradation was earlier shown during mild NaOH pretreatment. Previously, researchers were not able to fractionate wood biomass treated at even harsher conditions with NaOH, followed by extrusion processing. However, in the current study, we show that the alkaline pulping allowed easy processing of the material without any clogging issues.

TABLE 1
Chemical composition of T. pungens grass washed and treated with 2% NaOH for 2 h at 80° C.

| | | | | | Acid | | | | Cellulose: | |
|---|---|---|---|---|---|---|---|---|---|---|
| | | | Man/Ara/ | Klason | soluble | Ex- | | Not | Hemi- | Cellulose: |
| | Glucan | Xylan | Gal/Rha | lignin | lignin | tractives | Ash | quantified | cellulose | Lignin |
| Sample | (%) | (%) | (%) | (%) | (%) | (%) | (%) | (%) | ratio | ratio |
| Grass | 37.8 ± 0.2 | 23.34 ± 0.03 | 3.87 ± 0.03 | 15.5 ± 0.2 | 2.89 ± 0.01 | 6.5 ± 0.2 | 2.30 ± 0.03 | 7.7 | 1.4 | 2.1 |
| washed | | | | | | | | | | |
| Alkali | 52.6 ± 0.2 | 22.42 ± 0.08 | 3.48 ± 0.02 | 11.4 ± 0.3 | 1.26 ± 0.01 | 2.17 ± 0.01 | 1.54 ± 0.04 | 5.2 | 2.0 | 4.2 |
| delignified | | | | | | | | | | |
| pulp | | | | | | | | | | |

Mechanical processing of the pulp was carried out using a twin screw extruder (TSE), high energy ball milling (HEBM) and high-pressure homogenisers and (HPH). The TSE processing was performed on a HAAKE PolyLab OS (Thermo Scientific, England) co-rotating twin-screw extruder with a screw diameter of 16 mm and a barrel length to diameter ratio (L/D) of 40:1. The material was hand-fed into the extruder at approximately 15% solid content and the screw speed was kept at 90 rpm, using between 1 and 10 passes. The die was removed from the end of the extruder to ease pulp outflow. No external heating was applied in the extruder barrel. The torque applied on the screws was recorded with the PolyLab OS software and the data is presented as an average and standard deviation. The extruded samples are denoted as X-followed by a number of times the material was passed through e.g. X-1 for the sample extruded once.

The HEBM processing was performed on a laboratory agitator bead mill LabStar (Netzch, Germany). The pulp was diluted to approximately 0.7% (w/v) with water and processed in a continuous mode for 20 or 40 minutes per liter of dispersion. The mill was packed with smooth-surface, 1 mm zirconium oxide beads ZetaBeads® Plus (Netzch, Germany) and was operated at 1000 rpm for the duration of the process. The feed pump speed was set to 60 rpm. The samples prepared with the use of the bead mill are denoted as M-, followed by the time of milling per 1 liter of suspension e.g. M-20 for the sample milled for 20 min L⁻¹. The samples extruded and then milled follow the notation for the extrusion and milling, as described above.

High pressure homogenization (HPH) was performed on Panther NS3006L pilot-scale high pressure homogenizer (GEA Niro Soavi, Italy) at a solid content of approximately 0.6% (w/v). Material was passed through the homogenizer at 400 bar, 700 bar and subsequently three times at 1100 bar. The sample prepared accordingly is denoted as H.

To evaluate the morphology of the fibers after mechanical treatments, CLSM and TEM were used. Here, we propose that confocal microscopy can be employed to observe the overall sample appearance on a micro-scale, which can be a good indication of nanofibrillation efficiency. In the literature, usually optical microscopy is used to evaluate pulp macro-scale dimensions (Rol et al. 2017) however, it does not provide good contrast between fibers and the background, which makes it difficult to image fibers and fiber bundles. The advantage of CLSM is that it allows for visualization of both large fibers, and smaller fiber bundles, when the material has been dyed with a fluorescent dye. Moreover, the sample can be reconstructed in a three-dimensional image. For the purpose of this work, four representative samples prepared via different mechanical treatments are shown. All samples show fibers of a few hundred micrometers in length, irrespective of the mechanical process used. The long (>200 nm) fibers are present even for the samples processed by homogenization (H), extrusion combined with milling (X-M), and milling alone (M). Nevertheless, in the case of samples H, X-3-M-20 and M-20, in between the relatively large, distinct fibers of a few hundreds of micrometers length, there appear to be a dense network of nano-fibrillated material observed in the confocal images. This is not the case of the sample X-3, which was processed by extrusion only, as well as the other extruded-only samples (data not shown). For the X-3 sample, the space in between the large fibers is relatively clear, without traces of fine, fluorescent material.

To evaluate the material morphology on the nano-scale, TEM was employed. It was found that all samples included at least some proportion of nanosized fibers, including the extruded-only material. The average diameter of the individual nanofibers were 8±2 nm, 11±3 nm, 10±3 nm and 10±3 nm for the H, X-3, X-3-M-20 and M-20 samples, respectively. According to the statistical analysis, sample H showed a significantly smaller (p<<0.05) diameter to the other samples. The size distribution of the fiber diameters presented in FIG. 3 indicates that most of the fibers of sample H are within the 7-8 nm bin range whereas, for the X-3, X-3-M-20 and M-20 samples most of the fibers are 9-10 nm in diameter. Moreover, for sample H only 1% of the fibers are within the largest measured diameter (15-16 nm) whereas, for the other samples around 7% (X-3-M-20) and 11-12% (X-3 and M-20) of fibers are within the largest measured diameter (15-20 nm). This shows that high pressure homogenization produces fibers with overall smallest diameter and the remaining methods produce fibers with similar average diameter and similar size distribution. This can be correlated to the high shear and impact forces utilized in the homogenization process, which results in higher fibrillation efficiency. The presence of nanofibers, as indicated by TEM, in the extruded-only pulp indicates that even this low-energy processing is able to produce CNF. However, the CNF quantity in the H, X-M and M samples seems to be higher than that of X samples based on the network density in the overall CLSM images

Handsheets from the processed spinifex samples were prepared using an automatic British handsheet maker (Mavis Engineering, England) with a target grammage of 80-85 g m⁻². The mechanically treated pulp was diluted to 0.3% (w/w), vigorously mixed, poured over a Whatman 541 filter paper, and drained. After drainage, the wet cake was pressed between two blotting papers with an automated couching system (sample H) or with 10 kg hand-roll (samples X and M) to remove excess water. Subsequently, the filter paper was removed and the samples were cold-pressed between fresh blotting papers for 5 min at 345 kPa on an L&W Sheet Press (AB Lorentzen & Wettre). The H sample was dried on a drum roll dryer at 105° C. for approximately 15 min. The X and M samples were air dried for 24 h (at 50% RH, 22° C.) on a steel plate, restrained by a metal ring with weight placed on top.

The mechanical properties of the handsheets allow a good evaluation of the fibrillation efficiency obtained via different processing techniques. The results of the tensile mechanical properties, burst strength, density, and porosity of the sheets are presented in Table 2.

TABLE 2
Mechanical and physical properties, and energy consumption
of handsheets produced with different processing methods.

| | Tensile | Strain | | | Burst | | | | Energy |
|---|---|---|---|---|---|---|---|---|---|
| | Index | at | Tensile | Young's | Strength | | | | con- |
| Sample | (kNm | break | Strength | Modulus | (kPa | Density | Porosity | Cr | sumption |
| name | g⁻¹) | (%) | (MPa) | (GPa) | m² g⁻¹) | (g cm⁻³) | (%) | I | (kWh/t)* |
| X-1 | 32 ± 4 ^{d} | 1.8 ± 0.4 ^{d} | 25 ± 3 ^{d} | 1.27 ± 0.07 | 1.9 ± 0.3 ^{d} | 0.75 ± 0.05 ^{b} | 48 ± 4 ^{b} | 74 | 326 |
| X-3 | 40 ± 2 | 2.1 ± 0.3 | 32 ± 2 | 1.9 ± 0.2 | 2.3 ± 0.1 | 0.82 ± 0.05 ^{b} | 44 ± 3 ^{b} | 74 | 476 |
| X-6 | 40 ± 3 | 1.8 ± 0.4 | 36 ± 3 | 2.1 ± 0.3 | 2.5 ± 0.2 | 0.91 ± 0.05 ^{d} | 38 ± 4 ^{d} | 72 | 601 |
| X-10 | 46 ± 8 | 2.0 ± 0.2 | 40 ± 7 | 2.0 ± 0.1 | 2.6 ± 0.3 ^{d} | 0.88 ± 0.06 ^{d} | 40 ± 4 ^{d} | 73 | 704 |
| X-3-M-20 | 77 ± 7 | 3.2 ± 0.8 | 83 ± 8 | 3.6 ± 0.4 | 5.3 ± 0.6 ^{a} | 1.09 ± 0.05 ^{d} | 25 ± 4 ^{d} | 72 | 114 761 |
| X-6-M-20 | 81 ± 5 | 3.5 ± 0.6 | 90 ± 6 | 3.5 ± 0.4 | 5.3 ± 0.5 ^{c} | 1.11 ± 0.06 ^{d} | 24 ± 4 ^{d} | 70 | 114 886 |
| X-10-M-20 | 79 ± 5 | 3.3 ± 0.5 | 85 ± 5 | 3.5 ± 0.4 | 5.7 ± 0.3 ^{b} | 1.08 ± 0.05 ^{d} | 26 ± 3 ^{d} | 71 | 114 990 |
| M-20 | 80 ± 4 | 3.0 ± 0.3 | 80 ± 4 | 2.5 ± 0.4 | 4.7 ± 0.3 ^{c} | 1.0 ± 0.1 ^{d} | 31 ± 7 ^{d} | 71 | 114 286 |
| M-40 | 82 ± 4 | 2.8 ± 0.5 | 87 ± 4 | 2.7 ± 0.4 | 5.0 ± 0.7 ^{b} | 1.07 ± 0.09 ^{d} | 26 ± 6 ^{d} | 68 | 228 571 |
| H | 84 ± 10 | 3.1 ± 0.7 | 84 ± 10 | 2.9 ± 0.3 | 6.2 ± 0.4 | 1.00 ± 0.02 ^{b} | 31 ± 2 ^{b} | 72 | 43300 |

Number of replicates for value,
n=
^{a}: 4;
^{b}: 5;
^{c}: 6;
^{d}: 9,
n = 10 otherwise.
*Value calculated based on a single experiment.

Sample H, shows significantly the highest tensile index (p<<0.05) of 89 Nm g⁻¹ amongst all samples. This was expected, as the homogenization process utilizes high shear and impact forces to push the material through a small orifice, which results in higher fibrillation efficiency. However, the handsheets, which were produced by extrusion and milling (X-M), or only milling (M), demonstrate similarly high tensile indices, in the range between 77-82 Nm g⁻¹. Moreover, there is no significant difference (p>0.05) in the tensile index values between samples that were processed with milling for 20 min L⁻¹ and 40 min L⁻¹. This implies that milling for 20 min L⁻¹ is sufficient to obtain nanofibrillated material. Previously, researchers observed that after five passes through extruder the tensile strength and elongation of films dropped significantly, presumably due to the degradation of material. In contrast to this, an increasing number of passes through the extruder in this study is associated with a significant increase in the tensile index of the handsheets (p<<0.05), except between three to six passes. However, subsequent additional extrusion passes did not increase the tensile index (p>0.05) if milling was performed as an additional processing method. The high tensile values of H, X-M, and M samples can be explained by their higher density, which is ≥1 g cm⁻¹ as compared to X samples, <0.9 g cm⁻¹. This, in turn relates to the lower porosity of the denser films, made from nano- rather than micro-fibrillated material, i.e. the H, X-M, and M. For the latter, the porosity was <31%, while for the extruded samples, which were a mixture of CNF and MFC fractions, the porosity was much higher, over 38%. In some instances the greater porosity of these X samples could be advantageous e.g. in the case of paper-based battery separators, where high-porosity, strong materials are required. The values of strain at break were significantly higher (p>0.05) for the samples processed with HEBM, as compared to extrusion. Surprisingly, the samples processed by milling showed also greater elasticity than the homogenized ones. The exception was sample M-40, which had a strain at break in a similar range to the H sample. The range of strain at break for the milled and extruded samples is between 2.8-3.5% and 1.8-3.2%, respectively. The tensile values obtained in this research are much larger than those previously reported in the literature. Researchers obtained elongation at break in the range of 0.4-0.8% and comparable tensile strength for similarly prepared samples of extruded Eucalyptus bleached pulp. Ball milling of bleached softwood pulp resulted in a 1.7% strain at break and much lower tensile index and strength of less than 30 Nm g⁻¹ and 12 MPa, respectively, at a 100 times lower throughput than in the current study. Similarly, commercial MFC milled at a throughput approximately three orders of magnitude lower than in our study resulted in a third of the tensile values as compared to M-20. The Young's modulus of the samples shows a similar trend to the tensile strength, with the highest values for the X-M and M samples, followed by H and X.

Although the sheets made from milled and homogenized samples are composed primarily of nano-sized cellulose fibers, the elastic moduli of these materials was still far from the theoretical modulus of a single cellulose I nanofiber, which is between 110-220 GPa. It should be mentioned however, that the nanofibers or nanofiber bundles are randomly oriented in the sheets therefore, reducing the maximum tensile strength. Furthermore, our spinifex-derived CNF and MFC comprise relatively high levels of residual non-crystalline cell wall polymers such as hemicellulose and lignin, with the hemicellulose in particular contributing towards a less elastic and more viscoelastic property profile (as indicated by the higher strain at break values). Nonetheless, the Young's moduli of the sustainable, spinifex-derived “paper” in the current study is comparable to many engineering polymers of similar density.

This study shows that the cellulose nanofibres have good adhesion, thereby opening up the possibility that a gel material comprising the cellulose nanofibres dispersed in an aqueous medium provide a good candidate for use as a natural adhesive.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A material containing cellulose nanofibres, the material comprising a gel material comprising cellulose nanofibres in an aqueous medium, the cellulose nanofibres having 10% or more by weight hemicellulose.

2. A material as claimed in claim 1 wherein the cellulose nanofibres have a diameter of less than 100 nm, or less than 50 nm, or less than 20 nm.

3. A material as claimed in claim 1 wherein the cellulose nanofibres have 15% or more by weight hemicellulose, or the cellulose nanofibres have 20% or more by weight hemicellulose, or the cellulose nanofibres have 25% or more by weight hemicellulose, or the cellulose nanofibres have 30% or more by weight hemicellulose.

4. A material as claimed in claim 1 wherein the cellulose nanofibres include cellulose, hemicellulose, lignin and extractives.

5. A material as claimed in claim 4 wherein the cellulose nanofibres comprise from 10 to 25%, by weight, lignin, 35 to 70% by weight cellulose and 2 to 10%, or 2 to 8% extractives.

6. A material as claimed in claim 1 wherein the gel contains from 2 mg/ml (w/V) cellulose nanofibres to 20% w/V cellulose nanofibres, or from 2 mg/ml (w/V) to 15% w/V cellulose nanofibers.

7. A material as claimed in any claim 1 wherein the gel material has rheology modifiers added to the gel in order to effect or controlled the rheology of the gel.

8. A material as claimed in claim 1 wherein the aqueous medium comprises water.

9. A material as claimed in claim 1 wherein the aqueous medium comprises water and an alkali.

10. A material as claimed in claim 9 wherein the aqueous medium has a pH of greater than 7.

11. A material as claimed in claim 1 wherein the aqueous medium comprises an aqueous medium remaining with the cellulose nanofibres following treatment of a plant material to form the cellulose nanofibres following a mild alkali treatment, the mild alkali treatment including treating the plant material with an alkali solution having an alkalinity equivalent to 2% to 15% NaOH, or 2% to 14%, or 2% to 10%, or 2% to 7%, or 2% to 5% NaOH.

12. A method for forming the material as claimed in claim 1 any one of the preceding claims comprising treating plant material with a mild alkali treatment, followed by mechanical processing to form the cellulose nanofibres.

13. A method as claimed in claim 12 wherein the plant material is washed with water following the mild alkali treatment to remove dissolved material from the plant material, subjecting a pulp containing the alkali treated plant material and water to mechanical processing selected from shear mixing, high-energy ball milling, passing the pulp through an extruder, such as a twin screw extruder, high-pressure homogenisation to cause mechanical disintegration of the plant material into microfibrillated cellulose or cellulose nanofibres and form a product comprising a material containing water and cellulose nanofibres and optionally removing part of the water removed therefrom to form the gel material.

14. A method as claimed in claim 12 wherein a pulp resulting from the mechanical processing is dried to recover the cellulose nanofibres and the gel material is formed by subsequently adding an aqueous medium to the dried fibres.

15. Paper made from cellulose nanofibres, characterised in that the cellulose nanofibres have a hemicellulose content of at least 10% by weight.

16. A method for making the paper of claim 15 by dewatering a pulp or gel material as claimed in containing the cellulose nanofibres.

17. A product having a first component adhered to a second component, characterised in that gel material comprising cellulose nanofibres having 10% or more, by weight, hemicellulose in an aqueous medium is used as an adhesive to adhere the first component to the second component.

18. A product as claimed in claim 17 comprising a laminate having a first sheet and a second sheet adhered to the first sheet, with the gel layer adhering the first sheet to the second sheet.

19. A product as claimed in claim 18 wherein the laminate comprises a plurality of sheets, with a gel layer being located between each sheet in order to adhere the gel layer to each sheet.

20. A product as claimed in claim 19 wherein the sheets comprise paper sheets, sheets of hemp, sheets of flax, fibreglass sheets, cardboard sheets, cloth sheets, fabrics sheets, woven sheets, non-woven sheets, polymeric materials or biodegradable polymeric materials.

21. A product as claimed in claim 19 wherein the laminate is used as a packaging material.

22. A product as claimed in claim 18 wherein biodegradable thermoplastics and/or fire retardants are added to the laminate.

23. A product as claimed in claim 22 wherein the biodegradable thermoplastics and/or fire retardants are added to the gel layer or the fire retardants are present in the sheet material.

24. A process for producing an article in which a first component is adhered to a second component, the process comprising applying a layer of the gel material as claimed in claim 1, placing at least part of the second component in contact with the gel material and dewatering the gel material such that the first component adheres to the second component.

25. A method as claimed in claim 24 wherein the first component, gel material and second component are pressed together.

26. A method as claimed in claim 25 wherein the first component, gel material and second component are hot pressed together.

27. A method as claimed in claim 24 wherein the article is heated in order to remove water from the gel layer.

28. A method as claimed in claim 24 wherein the first component and the second component comprise a first sheet and a second sheet and the article comprises a laminate and the laminate is formed into a shaped product by placing the first sheet, the gel layer and the second sheet into a mould and pressing the further sheet, gel layer and second sheet into the mould.

29. A composite material comprising a matrix made from cellulose nanofibres having a hemicellulose content of at least 10% by weight, the composite material including one or more property modifying agents.

30. A composite material as claimed in claim 29 wherein the one or properly modifying agents comprise a reinforcing agent.

31. A composite material as claimed in claim 30 wherein the reinforcing agent comprises glass fibre, carbon fibre, graphene, metal fibres, flake material, or platelet-shaped material.

32. A composite material as claimed in claim 29 wherein the one or more property modifying agents are dispersed throughout the matrix made from the cellulose nanofibres.

33. A composite material as claimed in claim 29 wherein the composite material comprises at least 60% by weight, or at least 70% by weight, or at least 80% by weight, or at least 85% by weight, or at least 90% by weight, or at least 95% by weight, or at least 97% by weight, or at least 98% by weight, or at least 99% by weight, of the matrix made from cellulose nanofibres and the one or more property modifying agents comprise less than 40% by weight, or less than 30% by weight, or less than 20% by weight, or less than 50% by weight, or less than 10% by weight, with 5% by weight, or less than 3% by weight, or less than 2% by weight, or less than 1% by weight, of the composite material.

34. A material as claimed in claim 1 wherein the cellulose nano fibres are derived from a grass species having C4-leaf anatomy, or the cellulose nanofibres are derived from plant material is derived from a drought-tolerant grass species, or an arid grass species, or from Australian native arid grass known as “spinifex” of genera which include Triodia, Monodia, and Symplectrodia or from T. pungens, T. shinzii or T. basedowii, T. longiceps.
